(19) United States
(12) Patent Application Publication
(10) Pub. No.: US 2026/0050183 A1
(43) Pub. Date: Feb. 19, 2026

(54) Gain Equalizer

(71) Applicant: Nippon Telegraph and Telephone Corporation, Tokyo (JP)

(72) Inventors: Yoshie Morimoto, Musashino-shi, Tokyo (JP); Kenya Suzuki, Musashino-shi, Tokyo (JP); Keita Yamaguchi, Musashino-shi, Tokyo (JP)

(21) Appl. No.: 19/103,129

(22) PCT Filed: Aug. 15, 2022
(86) PCT No.: PCT/JP2022/030896

§ 371 Date: Feb. 11, 2025

(51) Int. Cl. G02F 1/01

(52) U.S. Cl. CPC G02F 1/011; G02F 1/0102

(57) ABSTRACT

A gain equalizer using a lattice optical circuit with a smaller polarization-dependent loss is provided. The gain equalizer includes: 2M optical waveguide circuits formed on a substrate, wherein M is an integer of 1 or more, including M pairs of optical waveguide circuits, each pair of optical waveguide circuits having the same gain equalization spectrum; and a folding connection structure that connects input/output waveguides of a pair of optical waveguide circuits, the folding connection structure rotating a polarization direction of propagating light by 90 degrees,

### TECHNICAL FIELD

The present invention relates to a gain equalizer configured by a polarization-independent optical waveguide circuit.

### BACKGROUND ART

Optical communication networks are rapidly evolving against the backdrop of the sharp increase in amount of data communication, represented by that of the Internet. Among these, optical wavelength division multiplexing (WDM) allows multiple wavelength signals to be transmitted through a single optical fiber, which is regarded as an essential tool to implement large-capacity optical communications. Devices such as wavelength multiplexer/demultiplexers or optical amplifier play important roles in WDM. In particular, when adopting WDM in long-distance transmission over 100 km, it is necessary to arrange optical amplifiers at regular intervals in a transmission fiber, and the wavelength dependence of the gain spectrum thereof significantly affects an optical signal-to-noise ratio (OSNR). For example, a gain equalizer disclosed in NPL 1 has been proposed for flattening the gain spectrum.

There are several methods for implementation of various optical functional circuits required in optical communication networks. For example, so-called planar lightwave circuits (PLCs), in which an optical waveguide made of a quartz-based material is formed on a silicon substrate, are widely used as a circuit that is multi-functional, mass-producible, and inexpensive.

Optical circuits with silica-based glass waveguides employ the same material as optical fibers used in optical communications, so they are capable of having low-loss optical waveguides. Furthermore, since waveguides are formed on a planar substrate, it is easy to combine various functional elements, and complex optical circuits can be fabricated with excellent reproducibility. Wavelength multiplexing/demultiplexing elements and optical switches can be fabricated using such methods and serve as essential components in constructing optical network.

The gain equalizer disclosed in NPL 1 has a configuration in which Mach-Zehnder interferometers are connected in multiple stages, and therefore has a drawback of large loss. This is based on the essential cause that optical signals are discarded to unconnected output ports in Mach-Zehnder interferometers at each stage. On the other hand, NPL 2 discloses a gain equalizer having a configuration called a lattice circuit.

A gain equalizer using a lattice optical circuit is configured by N−1 arm waveguides each consisting of N directional couplers and two waveguides interposed therebetween. Furthermore, a phase of light propagating through the waveguides is controlled by a phase shift that employs a change in refractive index due to the thermo-optic effect, caused by applying heat to either one of the arm waveguides. By adjusting a phase difference between the optical signals propagating through the two waveguides configuring the arm waveguide of the directional coupler at the front stage, the interference in the directional coupler at the rear stage can also be adjusted, thereby controlling a transmission spectrum for a wavelength of the propagating light.

FIG. 1 illustrates an example of a gain equalization spectrum in the conventional lattice optical circuit. A horizontal axis represents a wavelength of light, and a vertical axis represents a light intensity transmittance of a gain equalizer. The wavelength range required for the gain equalizer is assumed to be Δλ₁ (1525 to 1570 nm in FIG. 1). The minimum transmittance of the light intensity within Δλ₁ is Lossₘₐₓ (−9 dB in FIG. 1), and the maximum transmittance is Lossₘᵢₙ (−0.34 dB in FIG. 1). A difference between Lossₘₐₓ and Lossₘᵢₙ will be referred to as transmission attenuation. The desired spectrum shape only needs to be maintained within Δλ₁, and a spectrum shape in other wavelength ranges is not particularly limited. In addition to the spectrum shape shown in FIG. 1, for example, if a spectrum in which the transmittance changes linearly with respect to wavelength within Δλ₁ is implemented, the gain equalizer operates as a tilt equalizer. In this case as well, a slope (dB/nm) of the spectrum shape is controlled by adjusting the amount of phase shift in each arm waveguide.

However, for the gain equalizer configured by the lattice optical circuit, when the interference differs depending on a polarization direction of the light propagating in the optical circuit, the transmission spectrum finally output from the lattice optical circuit has polarization dependence. The polarization dependence of the transmission spectrum appears as polarization-dependent loss (PDL) in terms of a circuit characteristic of the optical circuit. In particular, for a lattice optical circuit with a large number of stages, a PDL generated in one arm waveguide is amplified each time it passes through the lattice stages, so the PDL of the entire lattice optical circuit becomes larger.

The PDL is found when birefringence is present in the optical waveguide and there is a difference between effective refractive indexes depending on the polarization of a propagating optical signal. The birefringence Δn_{eff} of the optical waveguide is defined by Equation (1).

$$[ Math . 1 ]$$

$$Δ {n}_{eff} = {n}_{y} - {n}_{x} \qquad ( 1 )$$

In the above equation, n_{y} denotes an effective refractive index in the Y direction, and nₓ denotes an effective refractive index in the X direction. In a case where the (effective refractive index in Y direction) is larger than the (effective refractive index in X direction), the birefringence Δn_{eff} takes a positive value, and in a case where the (effective refractive index in Y direction) is smaller than the (effective refractive index in X direction), the birefringence Δn_{eff} takes a negative value. In an optical waveguide where Δn_{eff} is not 0, two orthogonal polarization modes propagate, including: a TM mode having an electric field component perpendicular to a substrate surface and a TE mode having an electric field component in the horizontal direction.

The gain equalizer using the lattice optical circuit controls the phase shifter using a thermos-optic effect in the arm waveguides of the plurality of directional couplers to control a wavelength spectrum finally output. For the i-th arm waveguide of the lattice optical circuit at (N−1)th stage, configured by N directional couplers and N−1 arm waveguides each consisting of two waveguides interposed therebetween, the phase difference Θᵢ between an upper arm waveguide and a lower arm waveguide is defined by Equation (2).

$$[ Math . 2 ]$$

$${Θ}_{i} = \frac{2 π}{λ} {n}_{eff} Δ {L}_{i} + {ϕ}_{i} \qquad ( 2 )$$

In the above equation, λ denotes the wavelength of light, n_{eff} denotes the effective refractive index of the optical waveguide, ΔLᵢ denotes the difference in length between the upper arm waveguide and the lower arm waveguide in the i-th arm waveguide, and qi denotes the phase difference added between the arm waveguides by controlling the phase shifter in the i-th arm waveguide. When configuring the gain equalizer with the lattice optical circuit, a desired gain equalization spectrum is obtained by appropriately controlling the phase difference φᵢ applied between each arm waveguide.

In a case where birefringence exists in the optical waveguide and the effective refractive index of the TE mode and the effective refractive index of the TM mode are different from each other at this time, the phase difference represented by Equation (2) varies depending on the polarization mode, and accordingly the interference in the subsequent directional coupler differs depending on the polarization mode, thereby producing the PDL.

On the other hand, in the Mach-Zehnder interferometer, polarization dependence also occurs due to asymmetric rotation of polarization between the arm waveguides. Polarization rotation in the optical waveguide is suppressed by finite birefringence, as is generally known in polarization-maintaining fibers. Therefore, even if the absolute value of birefringence represented by Equation (1) is reduced and the difference in the interference caused only by birefringence is eliminated, polarization dependence still occurs due to the influence of polarization rotation.

As described above, the conventional gain equalizer with the lattice optical circuit has a disadvantage in that polarization-dependent loss (PDL) cannot be completely eliminated.

### CITATION LIST

### Non Patent Literature (NPL)

[NPL 1] K. Suzuki, T. Kitoh, S. Suzuki, Y. Inoue, Y. Hbbino, T. Shibata, A. Mori, and M. Shimizu, “Ultra wide range dynamic gain equalizer with high contrast silica planar lightwave circuit,” in Integrated Photonics Research, A. Sawchuk, ed., Vol. 78 of OSA Trends in Optics and Photonics (Optical Society of America, 2002), paper IThG2.
[NPL 2] T. R. Schlipf, M. W. Street, J. Pandavenes, R. McBride, and D. R. S. Cumming, “Design and Analysis of a Control System for an Optical Delay-Line Circuit Used as Reconfigurable Gain Equalizer,” Journal of Lightwave Technology, Vol. 21, Issue 9, pp. 1944 (2003).

### SUMMARY OF INVENTION

An object of the present invention is to provide a gain equalizer using a lattice optical circuit with a smaller polarization-dependent loss.

In order to achieve the object stated above, a gain equalizer according to one aspect of the present invention includes: 2M optical waveguide circuits formed on a substrate, wherein M is an integer of 1 or more, including M pairs of optical waveguide circuits, each pair of optical waveguide circuits having the same gain equalization spectrum; and a folding connection structure that connects input/output waveguides of a pair of optical waveguide circuits, the folding connection structure rotating a polarization direction of propagating light by 90 degrees.

### BRIEF DESCRIPTION OF DRAWINGS

FIG. 1 illustrates an example of a gain equalization spectrum in a conventional lattice optical circuit.

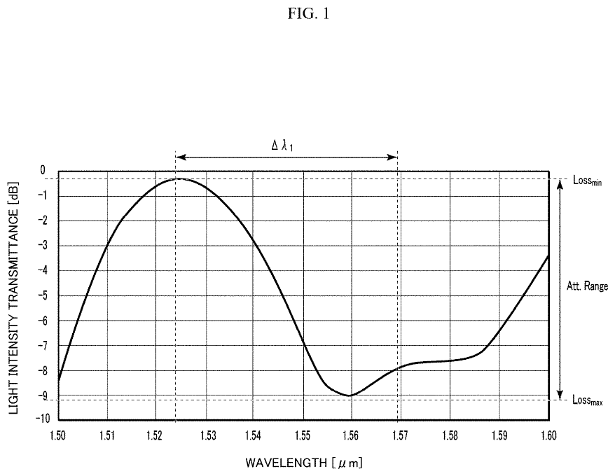

FIG. 2 is a diagram illustrating a configuration of a gain equalizer according to a first embodiment of the present invention.

FIG. 3 is a diagram illustrating a first example of a folding connection structure in the gain equalizer according to the first embodiment.

FIG. 4 is a diagram illustrating a second example of the folding connection structure in the gain equalizer according to the first embodiment.

FIG. 5 is a diagram illustrating a third example of the folding connection structure in the gain equalizer according to the first embodiment.

FIG. 6 is a diagram illustrating a configuration of a gain equalizer according to a second embodiment of the present invention.

FIG. 7 is a diagram illustrating a first example of a folding connection structure in the gain equalizer according to the second embodiment.

FIG. 8 is a diagram illustrating a second example of the folding connection structure in the gain equalizer according to the second embodiment.

FIG. 9 is a diagram illustrating a third example of the folding connection structure in the gain equalizer according to the second embodiment.

### DESCRIPTION OF EMBODIMENTS

Embodiments of the present invention will be described in detail below with reference to the drawings.

### First Embodiment

### (Configuration)

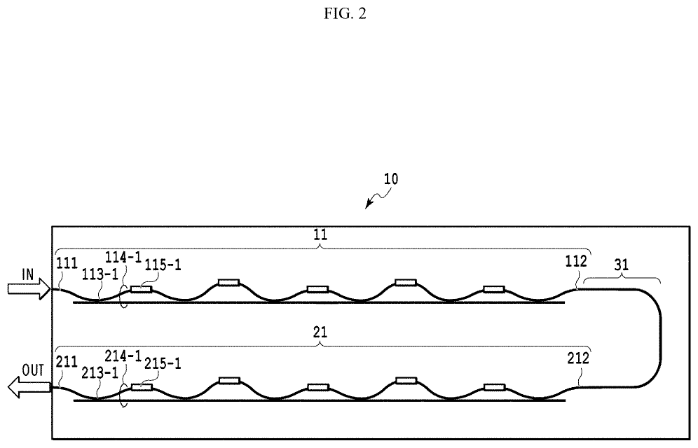

FIG. 2 is a diagram illustrating a configuration of a gain equalizer according to a first embodiment of the present invention. A gain equalizer 10 is configured by a PLC and illustrates a circuit configuration in which a configuration of an optical waveguide circuit formed on a substrate is viewed from above. The gain equalizer 10 is configured by an even number of lattice optical circuits (a first lattice optical circuit 11 and a second lattice optical circuit 21) and a folding connection structure 31 that connects input/output waveguides of a pair of lattice optical circuits.

The first lattice optical circuit 11 includes a first input/output waveguide 111, a plurality of optical directional couplers 113-1 to 113-N, arm waveguides 114-1 to 114-(N−1), and a second input/output waveguide 112. N is an integer of 3 or more. The optical directional couplers 113-1 to 113-N may be any optical circuit elements as long as they are 2-input 2-output optical multiplexing/demultiplexing circuits. The arm waveguides 114-1 to 114-(N−1) include two waveguides that connect two optical directional couplers, and at least one of the waveguides is loaded with phase shifters 115-1 to 115-(N−1). An optical signal input from the first input/output waveguide 111 passes through the optical directional couplers 113-1 to 113-N and the arm waveguides 114-1 to 114-(N−1) in this order. The signal is output from the second input/output waveguide 112.

The second lattice optical circuit 12 has the same design as the first lattice optical circuit 11, and similarly, includes a first input/output waveguide 211, a plurality of optical directional couplers 213-1 to 213-N, arm waveguides 214-1 to 214-(N−1), and a second input/output waveguide 212. It is also provided with phase shifters 215-1 to 215-(N−1).

The phase shifters 115-1 to 115-(N−1) and 215-1 to 215-(N−1) have a function of controlling the phase of the optical signal passing through them. Although the principle of the phase shifter is not particularly limited as long as it can control the phase of the optical signal that has passed through it, for example, a thermo-optic phase shifter using heat generated by a heater and thermo-optic effect may be adopted.

The second input/output waveguide 112 of the first lattice optical circuit 11 and the second input/output waveguide 212 of the second lattice optical circuit 21 are connected by the folding connection structure 31. With this structure, light propagating within the first lattice optical circuit 11 and output from the second input/output waveguide 112 is input to the second lattice optical circuit via the second input/output waveguide 212. The folding connection structure 31 has a function of rotating a polarization direction of propagating light by 90 degrees. A specific example of the folding connection structure 31 for implementing such a function will be described later.

### (Principle of Operation)

When the optical signal is input to the gain equalizer 10, the light is input to the first lattice optical circuit 11 via the first input/output waveguide 111. The input optical signal is subjected to gain equalization according to a gain equalization spectrum determined by the amount of phase modulation in the phase shifters 115-1 to 115-(N−1), and then output from the second input/output waveguide 112. At this time, since the gain equalization spectrum differs depending on the polarization direction of the light due to the PDL generated within the first lattice optical circuit 11, the spectrum of the output light from the second input/output waveguide 112 has polarization dependence.

The output light from the second input/output waveguide 112 is input to the second input/output waveguide 212 after propagating through the folding connection structure 31. At this time, since the folding connection structure 31 has a function of rotating the polarization direction of the propagating light by 90 degrees, it is input to the second input/output waveguide 212 while TE mode and TM mode of the optical waveguide are converted into each other.

The light input to the second lattice optical circuit 21 via the second input/output waveguide 212 is subjected to gain equalization according to a gain equalization spectrum determined by the amount of phase modulation in the phase shifters 215-1 to 215-(N−1), and then output from the first input/output waveguide 211. At this time, it is desirable that the phase modulation conditions for the phase shifters 115-1 to 115-(N−1) of the first lattice optical circuit 11 and the phase shifters 215-1 to 215-(N−1) of the second lattice optical circuit 21 be the same. That is, it is desirable that the gain equalization spectrum of the first lattice optical circuit 11 and the gain equalization spectrum of the second lattice optical circuit 21 be the same.

In the gain equalizer 10, the input optical signal passes through the first lattice optical circuit 11 and the second lattice optical circuit 21, which have the same design and the same phase modulation conditions. The light that is in the TE mode when transmitted through the first lattice optical circuit 11 undergoes a polarization rotation of 90 degrees in the folding connection structure 31, and is transmitted through the second lattice optical circuit 21 as the light in the TM mode. Therefore, the PDL generated in the first lattice optical circuit is offset by the PDL generated in the second lattice optical circuit. A gain equalizer with a smaller PDL can be achieved.

When an even number (2M: M is an integer of 1 or more) of lattice optical circuits are included, two lattice optical circuits with the same gain equalization spectrum are paired, and the second input/output waveguides of the pair of lattice optical circuits are connected to each other by the folding connection structure. Furthermore, the first input/output waveguides of M pairs of lattice optical circuits may be connected in cascade. In other words, the first input/output waveguide of the even-numbered lattice optical circuit and the first input/output waveguide of the odd-numbered lattice optical circuit are connected, and a section between the first input/output waveguide of the first lattice optical circuit and the first input/output waveguide of the 2M-th lattice optical circuit is configured as one gain equalizer.

### (Folding Connection Structure)

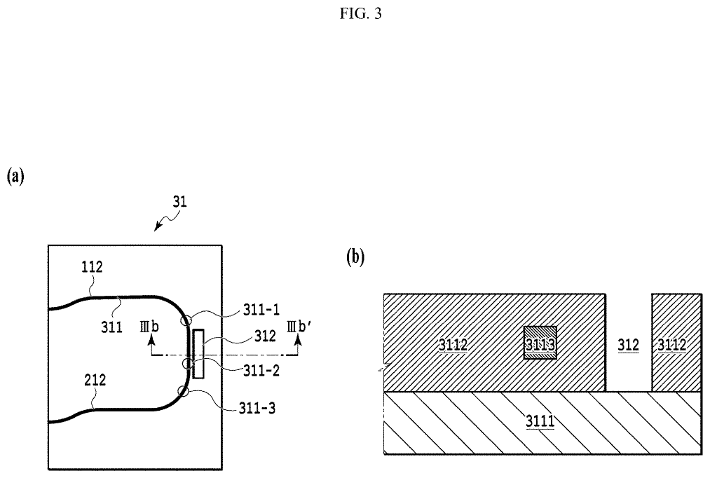

FIG. 3 is a diagram illustrating a first example of the folding connection structure in the gain equalizer according to the first embodiment. FIG. 3(a) shows a circuit configuration viewed from above, and FIG. 3(b) shows a cross section taken along a line IIIb-IIIb′ in FIG. 3(a). The folding connection structure 31 connects the second input/output waveguide 112 of the first lattice optical circuit 11 and the second input/output waveguide 212 of the second lattice optical circuit 12 by an optical waveguide 311. In a part of the optical waveguide 311, a groove 312 is formed along a part of the optical waveguide on one side with respect to the substrate plane.

As illustrated in FIG. 3(b), an optical waveguide core 3113 is embedded in a cladding 3112 of the optical waveguide formed on a substrate 3111. A cladding layer and a core layer of the optical waveguide can be formed by any method as long as it can form uniform and smooth layers; examples thereof include flame deposition, chemical vapor deposition (CVD), and sputtering.

Generally, in a quartz-based optical waveguide circuit, even if structural birefringence due to the structure of the optical waveguide is zero, thermal expansion coefficients of the substrate material, cladding material, and core material are different from each other. Thus compressive stress in a direction horizontal to the substrate acts on the core, resulting in stress birefringence. In particular, when flame deposition is adopted to form the cladding layer or core layer of the optical waveguide, a high-temperature process is involved during the fabrication of the optical waveguide, resulting in large compressive stress at room temperature and sharply increased birefringence. In this way, birefringence occurs in the core of the quartz-based optical waveguide, with the principal axis being in a direction perpendicular to the substrate or in a direction horizontal to the substrate.

When the groove is formed in the cladding portion on one side of the optical waveguide with birefringence along the core, asymmetrical stress is applied to the optical waveguide core, tilting the principal axis of birefringence. A way stress is applied depends on a distance from the waveguide core to the groove, and inclination of the principal axis of birefringence can be altered by adjusting this distance.

In a case where a linearly polarized wave passes through such a birefringent object whose principal axis is tilted, the polarization state of light propagating through the birefringent object varies depending on the angle θ between the polarization direction of the input light and the principal axis of the birefringent object, the magnitude of birefringence Δn_{eff}, and the propagation distance L in the birefringent object. When these relationships satisfy Equation (3), a linearly polarized wave whose polarization direction is rotated by 2θ with respect to the input linearly polarized wave is output.

$$[ Math . 3 ]$$

$$k Δ {n}_{eff} L = π \qquad ( 3 )$$

In the above equation, k denotes the wave number of the input light. Based on this characteristic and adjusting θ, Δn_{eff}, and L, it is possible to provide a desired amount of polarization rotation to the input linearly polarized wave.

Also in the first example of the folding connection structure 31, the groove 312 is formed in the cladding portion on one side of the core with respect to a partial region of the optical waveguide 311, thus the polarization of transmitted light can be rotated with respect to the optical waveguide 311-2 in this region. By adjusting the distance from the optical waveguide 311 to the groove 312, the amount of polarization rotation in the optical waveguide 311-2 can be adjusted, and the amount of polarization rotation can also be adjusted to 90 degrees. The light that is in the TE mode in the optical waveguide 311-1 before passing through the region where the groove 312 is formed undergoes polarization rotation by around 90 degrees while propagating through the optical waveguide 311-2, and then, is converted into TM mode in the subsequent optical waveguide 311-3 after passing through the region. Therefore, the light input from the input/output waveguide 112 to the folding connection structure 31 is output from the input/output waveguide 212 with the polarization direction rotated by about 90 degrees. It is preferable to set the amount of polarization rotation to 90 degrees; however, considering fabrication errors, the polarization-dependent loss can be sufficiently reduced in actual operation as long as it is possible to rotate the polarization by around 90 degrees.

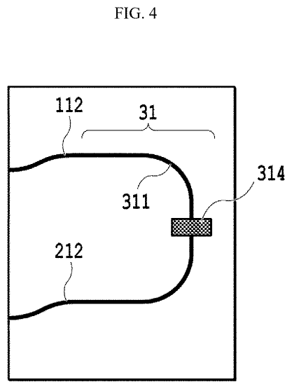

FIG. 4 is a diagram illustrating a second example of the folding connection structure in the gain equalizer according to the first embodiment. The folding connection structure 31 connects the second input/output waveguide 112 of the first lattice optical circuit 11 and the second input/output waveguide 212 of the second lattice optical circuit 12 by an optical waveguide 311. The optical waveguide 311 has a wavelength plate 314 inserted at least one location on the path. A ½ wavelength plate that shifts the phase difference between the principal axis and the slow axis by π is preferred as the wavelength plate. By installing the ½ wavelength plate so that its principal axis is inclined at 45 degrees with respect to the substrate surface of the optical waveguide 311, the polarization direction of the light propagating through the optical waveguide 311 is rotated by 90 degrees. Accordingly, the light input from the input/output waveguide 112 to the folding connection structure 31 is output from the input/output waveguide 212 with the polarization direction rotated by 90 degrees.

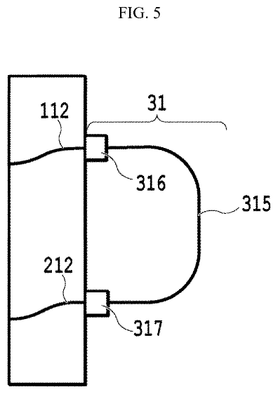

FIG. 5 is a diagram illustrating a third example of the folding connection structure in the gain equalizer according to the first embodiment. The second input/output waveguide 112 of the first lattice optical circuit 11 and the second input/output waveguide 212 of the second lattice optical circuit 12 are formed up to the end surface of the PLC substrate, and end surfaces of respective waveguides are connected by a polarization-maintaining fiber 315. The polarization-maintaining fiber 315 maintains the polarization state of light propagating through the fiber.

A connection point between the second input/output waveguide 112 and the polarization-maintaining fiber 315 is referred to a connection point 316, and a connection point between the second input/output waveguide 212 and the polarization-maintaining fiber 315 is referred to a connection point 317. The polarization-maintaining fibers 315 are connected such that the principal axis direction of the polarization-maintaining fiber 315 at the connection point 316 and the principal axis direction of the polarization-maintaining fiber 315 at the connection point 317 are different from each other by about 90 degrees. Accordingly, the light that is in the TE mode in the input/output waveguide 112 is input into the input/output waveguide 212 as the light in the TM mode after propagating through the polarization-maintaining fiber 315. Accordingly, the light input from the input/output waveguide 112 to the folding connection structure 31 is output from the input/output waveguide 212 with the polarization direction rotated by around 90 degrees.

According to the gain equalizer 10 according to the first embodiment, the PDL of the gain equalizer configured by the lattice optical circuit is resolved by means of the folding connection structure 31 of any one of the first to third examples.

### Second Embodiment

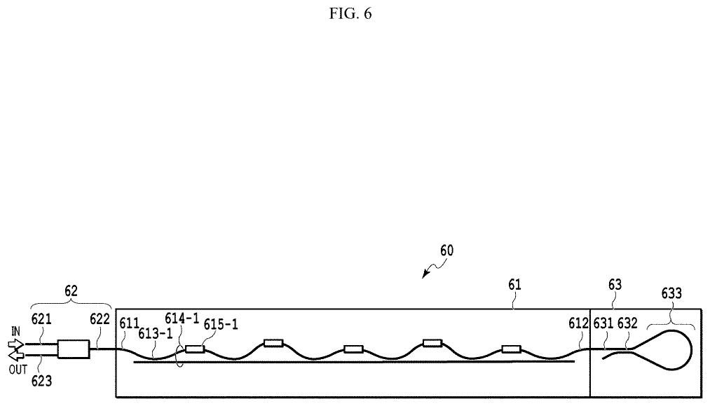

FIG. 6 is a diagram illustrating a configuration of a gain equalizer according to a second embodiment of the present invention. A gain equalizer 60 includes a lattice optical circuit 61, an input/output separation mechanism 62, and an optical folding unit 63. The lattice optical circuit 61 and the optical folding unit 63 are configured by PLCs and illustrate a circuit configuration in which a configuration of an optical waveguide circuit formed on a substrate is viewed from above. The lattice optical circuit 61 has the same configuration as the first lattice optical circuit 11 in the first embodiment, so the description thereof will be omitted.

As stated above, although the principle of the phase shifters 615-1 to 615-(N−1) is not limited as long as it can control the phase of the optical signal that has passed through it, for example, a thermo-optic phase shifter using heat generated by a heater and thermo-optic effect may be adopted. In the case of the thermo-optic phase shifter, the heat generated is controlled by the amount of current applied to the heater, and the accompanying refractive index alteration and phase modulation amount are controlled. The larger the amount of phase modulation to be applied, the larger the amount of drive current required.

The optical folding unit 63 may be integrated with the lattice optical circuit 61, or may be externally connected via, for example, an optical fiber. As long as the light input from an input/output port 631 of the optical folding unit 63 is output from the input/output port 631 again, the structure of the optical folding unit 63 is not particularly limited.

The optical folding unit 63 of the second embodiment is configured by an optical directional coupler 632 which is a 2-input 2-output optical multiplexing/demultiplexing circuit, and a folding connection structure 633 that connects two output ports of the optical directional coupler 632. The light input from the input/output port 631 is separated into 50% intensities by the optical directional coupler 632. The separated light beams travel in opposite directions in the folding connection structure 633, interfere again in the optical directional coupler 632, and light with 100% optical intensity is output from the input/output port 631.

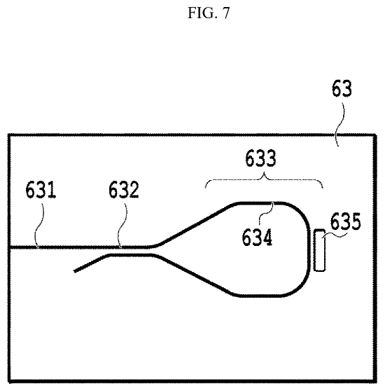

FIGS. 7 to 9 are diagrams illustrating first to third examples of the folding connection structure in the gain equalizer according to the second embodiment. The folding connection structure 633 has a function of rotating a polarization direction of propagating light by around 90 degrees. The configurations of the first to third examples of the folding connection structure 633 shown in FIGS. 7 to 9 are the same as the configurations of the first to third examples of the folding connection structure 31 shown in FIGS. 3 to 5.

The folding connection structure 633 illustrated in FIG. 7 has a groove 635 formed along a part of the folding optical waveguide on one side with respect to the substrate plane in a part of the folding optical waveguide 634. The groove 635 needs to be formed at a position where a path lengths from the two output ports of the optical directional coupler 632 are approximately equidistant.

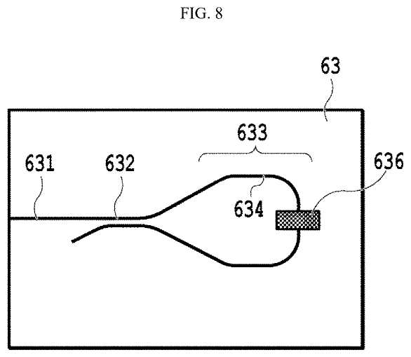

In the folding connection structure 633 shown in FIG. 8, a wavelength plate 636 is inserted at least one location on the path of the folding optical waveguide 634. A half-wavelength plate 636 needs to be provided at a position where a path lengths from the two output ports of the optical directional coupler 632 are approximately equidistant.

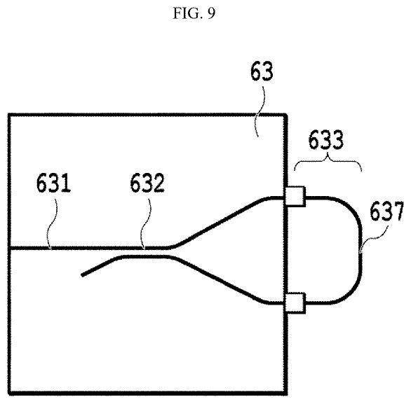

In the folding connection structure 633 shown in FIG. 9, two output ports of the directional coupler 632 are formed up to the end surface of the PLC substrate of the optical folding unit 63, and end surfaces of respective waveguides are connected by a polarization-maintaining fiber 637.

The input/output separation mechanism 62 may be integrated with the lattice optical circuit 61, or may be externally connected via, for example, an optical fiber. The input/output separation mechanism 62 has ports 621 to 623. The input light from the port 621 is output from the port 622, and the input light from the port 622 is output from the port 623. Examples of the input/output separation mechanism 62 include a 3-dB coupler or a wavelength-independent coupler when integrated with the lattice optical circuit 61, and an optical circulator when connected externally.

### (Principle of Operation)

With the above configuration, the operation of the gain equalizer according to the second embodiment will be explained. When the optical signal is input to the port 621 of the gain equalizer 60, it is input to the input/output separation mechanism 62 and output from the port 622. The light output from the port 622 is input to the lattice optical circuit 61 via the input waveguide 611.

The optical signal input to the lattice optical circuit 61 is subjected to gain equalization according to a gain equalization spectrum determined by the amount of phase modulation in the phase shifters 615-1 to 615-(N−1), and then output from the output waveguide 612. The propagation direction of the output light from the output waveguide 612 is reversed by the optical folding unit 63, and the light is again input to the lattice optical circuit 61 via the output waveguide 612.

The optical signal propagates within the lattice optical circuit 61 in a direction opposite to the direction in which it passes through the lattice optical circuit for the first time, and is output from the input waveguide 611. The output light from the lattice optical circuit 61 is input to the input/output separation mechanism 62 via the port 622 and output from the port 623.

In the gain equalizer 60 of the second embodiment, the input optical signal passes through the lattice optical circuit 61 twice, in the forward direction and in the reverse direction. In other words, it performs a reciprocating motion. Due to the principle of backward propagation of light, the transmission spectra are the same in a case where the optical signal is input from the input waveguide 611 and output from the output waveguide 612 for the lattice optical circuit 61, and in a case where the optical signal is input from the output waveguide 612 and output from the input waveguide 611 for the lattice optical circuit 61. Therefore, when the lattice optical circuit 61 of the second embodiment adopts a reciprocating motion, it is possible to obtain the same gain equalization effect as when the light transmits one lattice optical circuit twice.

In the gain equalizer 60, when the light performs a reciprocating motion in the lattice optical circuit, the light that is in the TE mode when it goes out undergoes polarization rotation in the optical folding unit 63, and is transmitted through the lattice optical circuit when it comes back as the light in the TM mode. Therefore, the polarization-dependent characteristic is eliminated by the reciprocating motion, and a gain equalizer with a smaller PDL can be achieved.

### (Low Power Consumption Due to Reciprocating Motion)

In the gain equalizer 60 of the second embodiment, the light beams perform a reciprocating motion in the lattice optical circuit. When the amount of phase modulation in each phase shifter 615-1 to 615-(N−1) is fixed, the amount of transmission attenuation of the obtained gain equalization spectrum is doubled compared to the case of conventional one-way operation. In other words, when the desired gain equalization spectrum is present, the gain equalizer 60 of the second embodiment has half the amount of transmission attenuation for one lattice optical circuit compared to the conventional one-way gain equalizer. For example, if it is desired to operate the gain equalizer 60 of the second embodiment in the range of transmission attenuation of 0 to 8 dB, transmission attenuation in the range of 0 to 4 dB is sufficient for the single lattice optical circuit 61. In this way, since the range of transmission attenuation necessary for the lattice optical circuit 61 can be narrowed, the range of necessary phase modulation amount can also be narrowed, and thus the amount of drive current for the phase shifter can be reduced. That is, it is possible to reduce power consumption.

As one example, it is assumed that a tilt equalizer is configured by a lattice optical circuit with N=6. In this tilt equalizer, the optical circuit is designed so that the gain equalization spectrum in the initial state (when no modulation is performed) has a waveform with a slope of 0. When it is intended to output a gain equalization spectrum with a spectrum waveform slope of 0.2 dB/nm (corresponding to transmission attenuation=8 dB in the C band of the optical communication wavelength band), according to the gain equalizer 60, as for the operation of the single lattice optical circuit 61, gain equalization with a spectrum waveform slope of 0.1 dB/nm may be needed (corresponding to transmission attenuation=4 dB in the C band). At this time, the required power consumption can be reduced by approximately 25% compared to the gain equalizer with the conventional one-way lattice optical circuit.

According to the gain equalizer 60 of the second embodiment, it is possible to provide a gain equalizer capable of implementing a gain equalization spectrum with a high degree of freedom with low power consumption while suppressing the PDL of the gain equalizer configured by the lattice optical circuit.

### OTHER EMBODIMENTS

The gain equalizer 60 according to the second embodiment includes one lattice optical circuit 61, one input/output separation mechanism 62, and one optical folding unit 63. The number of lattice optical circuits is not limited to this, and a plurality of circuits may be included. For example, when n gain equalizers 60 (n is an integer of 2 or more) are connected in cascade, the output port of the input/output separation mechanism of the k-th (1<k<n−1) gain equalizer is connected to the input port of the input/output separation mechanism of the k+1-th gain equalizer. This is repeated from k=1 to k=n−1, and finally the signal is output from the output port of the input/output separation mechanism of the n-th gain equalizer. The configuration of the second embodiment is applied to the optical folding unit 63 of each gain equalizer 60 to configure one gain equalizer in which n gain equalizers 60 are connected in cascade. According to this configuration, it is possible to implement a gain equalization spectrum with a high degree of freedom with low power consumption while suppressing the PDL of the gain equalizer.

1. A gain equalizer comprising:
2M optical waveguide circuits formed on a substrate, wherein M is an integer of 1 or more, comprising M pairs of optical waveguide circuits, each pair of optical waveguide circuits having the same gain equalization spectrum; and
a folding connection structure that connects input/output waveguides of a pair of optical waveguide circuits, the folding connection structure rotating a polarization direction of propagating light by 90 degrees.

2. The gain equalizer according to claim 1, wherein
each of the optical waveguide circuits includes:
a first input/output waveguide;
N 2-input 2-output optical multiplexing/demultiplexing circuits, wherein N is an integer of 3 or more;
N−1 arm waveguides each consisting of two waveguides connecting between the optical multiplexing/demultiplexing circuits; and
a second input/output waveguide,
wherein a loaded phase shifter is provided in at least one of the arm waveguides.

3. A gain equalizer comprising:
an optical waveguide circuit formed on a substrate, which is configured by an input waveguide; N 2-input 2-output optical multiplexing/demultiplexing circuits, wherein N is an integer of 3 or more; N−1 arm waveguides each consisting of two waveguides connecting between the optical multiplexing/demultiplexing circuits; and an output waveguide, the optical waveguide circuit further including a loaded phase shifter provided in at least one of the arm waveguides; and
an optical folding unit that outputs the light input from the output waveguide to the output waveguide again, and rotates a polarization direction of propagating light by 90 degrees.

4. The gain equalizer according to claim 1, wherein the folding connection structure includes:
an optical waveguide that connects the input/output waveguides; and
a groove formed along a part of the optical waveguide on one side in the part of the optical waveguide with respect to a plane of the substrate.

5. The gain equalizer according to claim 1, wherein the folding connection structure includes:
an optical waveguide that connects the input/output waveguides; and
a wavelength plate inserted into the optical waveguide.

6. The gain equalizer according to claim 1, wherein the folding connection structure includes a polarization-maintaining fiber that connects the input/output waveguides.

7. The gain equalizer according to claim 3, wherein the optical folding unit includes:
a second 2-input 2-output optical multiplexing/demultiplexing circuit connected to the output waveguide;
a folding optical waveguide that connects two output ports of the second optical multiplexing/demultiplexing circuit; and
a groove formed along a part of the folding optical waveguide on one side in the part of the folding optical waveguide with respect to a plane of the substrate.

8. The gain equalizer according to claim 3, wherein the optical folding unit includes:
a second 2-input 2-output optical multiplexing/demultiplexing circuit connected to the output waveguide;
a folding optical waveguide that connects two output ports of the second optical multiplexing/demultiplexing circuit; and
a wavelength plate inserted into the folding optical waveguide.
